(19) United States
(12) Patent Application Publication
(10) Pub. No.: US 2005/0281940 A1
(43) Pub. Date: Dec. 22, 2005

(54) Food material reformed in mineral composition of beans or mugi-rui, method of manufacturing the same, and method of reforming mineral composition of beans or mug-rui

(75) Inventors: Fumio Hara, Amagasaki-shi (JP); Kazutaka Murakami, Taka-gun (JP); Susumu Muta, Osaka (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Green Co. Ltd.

(21) Appl. No.: 10/871,572

(22) Filed: Jun. 21, 2004

(51) Int. Cl. A23L 1/20

(52) U.S. Cl. 426/634

(57) ABSTRACT

A food material nutritionally enriched in mineral composition and improved in taste includes beans or Mugi-rui enriched in magnesium, or magnesium and sodium. The Mg/K chemical equivalent ratio (a ratio of chemical equivalent of magnesium with respect to chemical equivalent of potassium) of the beans falls within the range of 0.4 to 2.0, and Mg/K chemical equivalent ratio of the Mugi-rui falls within the range of 0.8 to 3.0. The food material is manufactured by immersing the beans or Mugi-rui in aqueous solution containing magnesium chloride, or magnesium chloride and sodium chloride, at a certain concentration for a certain period of time.

### BACKGROUND OF THE INVENTION

1. Field of the Invention

The present invention relates to a food material reformed in mineral composition of beans or ‘Mugi-rui’, a method of manufacturing the same, and a method of reforming mineral composition of beans or ‘Mugi-rui.’ More specifically, it relates to a food material improved in taste and reformed in mineral composition by enhancing the ratio of the chemical equivalent of Magnesium with respect to the chemical equivalent of potassium contained in beans or ‘Mugi’ as materials.

In this description, ‘Mugi’ and ‘Mugi-rui’ denote a generic term of wheat, barley, rye, oats and the like, respectively.

2. Description of the Related Art

The following description sets forth the inventor's knowledge of related art and problems therein and should not be construed as an admission of knowledge in the prior art.

In cooking beans or ‘Mugi’ as materials, it has been known that they increase in softness and taste by immersing them in water before the cooking.

Regarding rice sufficiently rich in embryo, it is recently revealed that immersion of rice in aqueous solution of an appropriate liquid temperature and pH for a certain period of time causes the rice to be physiological germination, thereby quickly converting a great deal of the immanent glutamine add into γ-aminobutyric add, which is depression type neurotransmitter, by the function of immanent enzyme, which improves the nutritional property (see Japanese Patent Publication No. 2,590,423).

In the meantime, beans or ‘Mugi-rui’ contain numerous components having trophicity nature, and one of them is mineral. For example, magnesium is contained in a whole-grain soybean of 100 g by about 220 mg (the amount of magnesium element. Same applied to the following description) and in a whole-grain shell-removed soybean by about 210 mg. Thus, soybeans are important nutrition sources for Japanese people.

Now, an adult male body, on average, includes about 1,160 g of calcium, about 150 g of potassium, about 63 g of sodium and about 25 g of magnesium.

Among these elements, it is known that magnesium functions as coenzyme (activation component) by conjugating with adenosine triphosphate (ATP) in activating at least 325 types of enzyme existing in a human body.

Other than the above, magnesium is very widely distributed and acts, e.g., contributes to the synthesis of DNAs and RNAs, participates in adjustment of concentration of potassium, sodium and calcium between an inside of a cell and an outside thereof, and contributes to formation of bones and teeth.

More importantly, magnesium is indispensable to communication of information in cranial-nerves system and muscular expansion and contraction. In this sense, magnesium is a special and exceptional trophicity component.

Therefore, it has been known that deficiency symptom due to insufficient intake of magnesium comes to the force in various forms, e.g., high blood pressure, arteriosclerosis, diabetes, heart disease, myocardial infarction (heart attack), cerebral infarction, muscular pain, hormonal disease, arrhythmic, sudden death, osteoporosis, and urolithiasis.

Among other things, for modern people having increased brainwork, symptoms due to intellectual fatigue, e.g., cranial-nerves system fatigue, chronic headache, shoulder and lower back pain, or arms-and-legs movement disorder, pose severe problems to such people.

According to the advice entitled “Nutritional Requirements for Japanese” prepared by Japan Health, Labor and Welfare Ministry, the target consumption of magnesium for an adult per day is 300 mg. The calculation using this numeral reveals that magnesium for only approximately 80 days is stored in an adult body.

In actual, the average magnesium consumption of a Japanese adult male is 200 mg and therefore it is considered to be about 100 mg shortage. Since magnesium tends to come short in a shorter time period as compared with calcium and potassium, it has been desired that well considered food materials capable of easily and sufficiently taking magnesium in dietary habits are developed and consumed.

Here, minerals of beans will be discussed. Japan origin beans contain plural types of minerals indispensable to human's nutrition. Examples of the main minerals include about 190 mg of potassium, about 220 mg of magnesium, about 240 mg of calcium, and normally 0 mg or the like of sodium, per 100 g soybeans (water content of 12.5%. Same applied to the following description).

Among other things, chemical correlation between potassium and magnesium contained at high rates in beans will be explained using “chemical equivalent.”

The chemical equivalent (Unit: mEq/100 g) of potassium is obtained by dividing the potassium content by 39.1 which is 1 (one) chemical equivalent thereof In the same manner, the chemical equivalent (Unit: mEq/100 g) of magnesium is also obtained by dividing the magnesium content by 12.16 which is 1 (one) chemical equivalent thereof.

Then, Mg·mEq/100 mg is divided by K·mEq/100 mg to obtain the ratio (Mg/K·mEq) of chemical equivalent of magnesium with respect to the chemical equivalent of potassium. Hereinafter, the ratio will be referred to as “Mg/K chemical equivalent ratio.”

It has been reported that the Mg/K chemical equivalent ratio is apt to converge on a certain range every grain type of rice, wheat, barley, etc. and that in grains considered to be excellent in taste the Mg/K chemical equivalent ratio is generally high (Horino, et al, Japanese Journal of Crop Science, Vol. 61 No. 1, p 29-33, 1992).

Furthermore, it is also known that the calcium content of grains has less influence to taste (Toshiro HORINO, Masahiro OKAMOTO, The Bulletin of the Chugoku National Agricultural Experiment Research Station, Vol. 10, p 1-15, 1992).

In cases where soybeans and ‘Mugi-rui’ are immersed in water, the contained mineral amount is affected by elution. In 24 hours, about 280 mg of potassium (K element amount) and about 10 mg of magnesium will be converted into aqueous phase, respectively, to thereby change the Mg/K chemical equivalent ratio.

Washing and/or immersion of beans or ‘Mugi-rui’, which is generally performed, aims to soften the beans or ‘Mugi-rui,’ and also has an effect to enhance elution of potassium which is considered to be undesirable in taste. However, as mentioned above, the washing and/or immersion also cause elution of magnesium, which is believed to be very important factors to be considered especially in terms of nutrition for human.

Germinated beans or ‘Mugi-rui’ are rich in mineral. However, during the germinating processing, a certain amount of magnesium will be lost during the immersion processing of these beans. Such elution or flow-out of magnesium is not preferable in view of the aforementioned “Nutritional Requirements.” Nevertheless, no magnesium elution preventing countermeasures are known at all, and therefore naturally no industrial countermeasure has been taken.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a food material made from beans or Mugi-rui and nutritionally preferably reformed in mineral composition and improved in taste.

Among other potential advantages, some embodiments can provide a method of manufacturing the aforementioned food material.

Among other potential advantages, some embodiments can provide a method of reforming mineral composition of beans or Mugi-rui.

In immersing beans or Mugi-rui in aqueous solution, the present inventors devised and could have successfully obtained a food material preferably reformed in mineral composition of beans or Mugi-rui, and improved in taste by devising immersion of beans or Mugi-rui in aqueous solution because specific odor of the food which can be felt after cooking also can be removed simultaneously.

According to a first aspect of a preferred embodiment of the present invention, a food material reformed in mineral composition is made from beans enriched in magnesium content, or magnesium content and sodium content, wherein Mg/K chemical equivalent ratio falls within the range of 0.4 to 2.0.

According to a second aspect of a preferred embodiment of the present invention, a food material reformed in mineral composition made from Mugi-rui enriched in magnesium content, or magnesium content and sodium content, wherein Mg/K chemical equivalent ratio falls within the range of 0.8 to 3.0.

The beans or Mugi-rui used as materials are not specifically limited. However, the beans or Mugi-rui are provided as foods, and therefore it is preferable to avoid materials giving unfavorable taste due to the reasons of breed characteristics and/or cultivation and giving bitter taste due to the breed characteristics.

According to a third aspect of a preferred embodiment of the present invention, a method of manufacturing a food material, comprises: immersing beans or Mugi-rui in aqueous solution containing magnesium chloride of concentration of 0.01 to 10.0% (weight/capacity) for more than one hour.

According to a fourth aspect of a preferred embodiment of the present invention, a method of reforming mineral composition of a bean, comprises: immersing beans in aqueous solution containing magnesium chloride for more than one hour to decrease potassium content of the beans and enrich magnesium content so that a chemical equivalent ratio of magnesium with respect to a chemical equivalent of potassium falls within the range of 0.4 to 2.0.

According to a fifth aspect of a preferred embodiment of the present invention, a method of reforming mineral composition of a bean, comprises: immersing Mugi-rui in aqueous solution containing magnesium chloride for more than one hour to decrease potassium content of the Mugi-rui and enrich magnesium content so that a chemical equivalent ratio of magnesium with respect to a chemical equivalent of potassium falls within the range of 0.8 to 3.0.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

Hereinafter, a food material using beans or Mugi-rui as materials according to the present invention and the method thereof will be explained.

The food material according to the present invention is a food material reformed in mineral composition obtained by enriching magnesium, or magnesium and sodium of beans or Mugi-rui.

In the beans reformed in mineral composition, it is preferable that the Mg/K chemical equivalent ratio falls within the range of 0.4 to 2.0, preferably 0.4 to 1.0, more preferably 0.4 to 0.7.

In the Mugi-rui reformed in mineral composition, it is preferable that the Mg/K chemical equivalent ratio falls within the range of 0.8 to 3.0, preferably 0.8 to 2.0, more preferably 0.8 to 1.2.

The food material reformed in mineral composition can be obtained by immersing beans or Mugi-rui in aqueous solution containing magnesium chloride of a certain concentration or in aqueous solution containing magnesium chloride and sodium chloride of a certain concentration.

As material beans used in the present invention, soybeans, kidney beans, broad beans, cow peas, lima beans, chick peas, and lentils can be exemplified. As soybeans, it is preferable to use black lentils (Gankui-mame (beans)) good in taste and rich in Mg content. This black lentils (Gankuii-mame) contains more Mg content than other beans and larger in Mg/K chemical equivalent ratio than other beans as shown in Examples which will be explained later, and therefore can be preferably used as material beans in the present invention. As material Mugi-rui, barley, wheat, rye and oats can be exemplified. As each material, selected materials appropriate for human consumption are prepared.

Next, a method of manufacturing the aforementioned food materials using aqueous solution containing magnesium chloride will be explained. In place of the magnesium chloride, another magnesium compound such as magnesium carbonate can be used. However, the aqueous solution containing magnesium chloride is around 6 in pH, and therefore the solution is preferable for use in manufacturing the food material according to the present invention.

The method of preparing the aqueous liquid containing magnesium chloride of a certain concentration is not specifically limited. For example, the aqueous liquid can be prepared by using magnesium chloride containing material or magnesium chloride containing water to be used as food additive, preferably, powder bittern or water bittern, more preferably, refined bittern in which the content ratio of calcium hydrochloride and potassium chloride is lower than that in original ocean water obtained by salt farm method. In the present invention, water obtained by removing NaC from deep-see water can be used from the view point of concentration.

Aqueous liquid which is 0.01% (weight/capacity, same applied to the following description) to 10.0%, preferably 0.3% to 0.9%, in magnesium chloride concentration is prepared by using the aforementioned materials.

The beans or Mugi-rui of 100 kg or less, preferably 60 to 30 kg, per the aforementioned aqueous liquid 100 litter are immersed in the aqueous liquid. The immersion is performed at the liquid temperature of 60° C. or less, preferably 8 to 17° C. for 1 (one) hour or more, preferably 1 to 48 hours, more preferably 1 to 24 hours, optimally 3 to 8 hours to thereby prevent the increase of general viable cell count. To the aqueous liquid, suitable quantity of ethanol, sodium hypochlorite, etc., can be added for the purpose of sterilization, and phosphoric and/or organic add can also be added for the purpose of pH control.

This operation causes potassium contained in the beans or Mugi-rui to be eluted into aqueous phase, and also causes magnesium contained in the aqueous liquid to permeate into the food materials to thereby enrich the food materials. For example, in the case of soybeans, in 24 hour immersion, potassium decreases by about 360 mg and magnesium increases by about 20 mg. Accordingly, the Mg/K chemical equivalent ratio increases from 0.37 to 0.50.

Thus, it is possible to obtain a food material reformed in mineral component having high Mg/K chemical equivalent ratio in which the potassium content is decreased and the magnesium content is increased as compared with original beans or original Mugi-rui. 3 (three) hours or more immersion, preferably 5 (five) hours or more immersion decreases specific odors of the food materials which can be felt after the cooking of soybeans or barleys, resulting in food materials which solved the problems of the present invention.

In cases of using the aqueous solution for immersing beans or Mugi-rui in which only sodium chloride is dissolved, the elution of potassium contained in the original food materials can be further enhanced. As a result, in the case of soybeans, potassium decreases by about 554 mg in 24 hours, and therefore the Mg/K chemical equivalent ratio increases to 0.43. However, the elution of magnesium is also enhanced, and therefore the magnesium content decreases by about 38 mg in 24 hours, which is not preferable.

Another embodiment of the present invention will be explained.

Initially, sodium chloride is added to the magnesium chloride aqueous solution of the aforementioned concentration by using sodium chloride containing substance for food addition, sodium chloride containing water or sea salt or common salt such as rock salt to prepare mixed water solution of sodium chloride concentration of 0.01% to 20.0%, preferably 1.0% to 6.0%. In this case, salt in which a certain amount of bittern is contained can be used. In the present invenbon, it is also possible to utilize a solution in which sea water is diluted approximately double so as to fall the concentration within the aforementioned range. In this case too, to the aqueous liquid, suitable quantity of ethanol, sodium hypochlorite, etc., can be added for the purpose of sterilization, and phosphoric add and/or organic acid can also be added for the purpose of pH control.

When the original materials are immersed in the aforementioned mixed aqueous solution containing magnesium and sodium of a certain concentration as mentioned above, the elution of potassium contained in the original beans or original Mugi-rui is further enhanced as compared with the aforementioned case. For example, in the case of soybeans, 24-hour-immersion causes a decrease of potassium of about 526 mg.

On the other hand, the enriched amount of magnesium of soybeans in 5-hour-immersion will be about 18 mg in the most preferable case. However, if the immersion time is shorter or longer than the above, it is not so preferable. For example, even if the immersion time exceeds 24 hours, the enriched amount will further increase by only about 1 mg, which is almost the same level as in the original food materials.

In cases where aqueous solution for immersing original food materials is prepared using both magnesium chloride and sodium chloride, the magnesium content will further increase when the immersion time is 1 hour or more, preferably 1 to 24 hours, more preferably 3 to 8 hours. For instance, in the case of soybeans, the Mg/K chemical equivalent ratio will increase from 0.37 to 0.45˜0.52, which can solves the problems to be solved by the present invention.

In the same manner as in the aforementioned case, if the immersion is performed for 3 hours or more, more preferably 5 hours or more, specific odors of food materials which can be felt after cooling soybeans or Mugi-rui can be decreased. As a result, problems to be solved by the present invention can be solved.

In this embodiment, the sodium amount to be enriched in soybeans increases as the immersion time increases and reaches about 390 mg after 24 hour-immersion.

As will be explained in the following examples, according to the sampling tests by seven samplers, in cases where the sodium content in the food materials is about 50 mg or less, none of samplers could acquire any taste derived from sodium chloride. However, in cases where the sodium content falls within the range of about 50 to about 285 mg, five samplers among seven samplers detected weak sweet taste. In cases where it exceeds about 285 mg, all samplers acquire dear salty taste.

That is, in the food materials obtained here, sweet taste or salty taste is strengthened in accordance with the increase of sodium chloride to be enriched. Therefore, by utilizing this function, a food material enriched in magnesium and given in weak sweet taste or salty state derived from sodium chloride can be obtained.

If necessary, the obtained food material can be further subjected to washing processing using water or the aforementioned sodium magnesium aqueous solution falling within the concentration range of 0.01 to 10.0%.

Furthermore, as publicly known, when the water content is kept 15% or less, the increase of general viable cell count and/or thermostable spore bacterial count can be prevented, resulting in enhanced storage life of food material. Therefore, it is preferable to add drying pressing such as water-drip processing using an appropriate device or container such as a stainless colander.

In cases where drying processing is performed, the addition of grinding processing and/or swelling processing can be easily performed, which enables the food material to be provided in various forms, e.g., in a powder form and in a grain form.

Examples of the present invention will be described below. It is understood, however, that the examples are for the purpose of illustration and the invention is not to be regarded as limited to any of the specific materials or condition therein.

### EXAMPLES

### Comparative Example 1

Soybeans (made in Japan) were classified into 7 groups. Each group of 500 g was put in deionized water of 1 letter, and immersed therein for the set period of time shown in Table 1. Thereafter, each group of soybeans was put in a stainless steel colander to drop the water and adjusted the water content into about 12.5% by foroed-air drying in a low temperature chamber of 4° C. Then, the soybeans of 30 g were grinded to obtain bean flour, and the bean flour of 1.000 g was measured and obtained.

The bean flour was put in 1% solution of hydrochloric acid of 100 ml and shaken well to extract the mineral. The extract was diluted suitably, and each of the content of potassium (K), magnesium (Mg) and sodium (Na) was measured with an atomic absorption photometer (HITACHI Z8200 made by Hitachi Seisakusyo). The measured results shown as “mg” in the original beans of 100 g are shown in Table 1. In the following disclosure, each mineral in the food material measured by the atomic absorption photometer will be expressed as K, Mg, or Na, and each content is described as each amount mg/100 g.

As will be apparent from Table 1, the K content and Mg content of the beans immersed in water clearly decreased as compared with the control soybeans not immersed in water. As the immersion time became longer, the reduction degree thereof increased. The Mg/K chemical equivalent ratio was 0.37 to 0.41, the most of them were less than 0.4.

As a result, in these groups, although the Mg/K chemical equivalent of an example reached 0.41, Mg content decreased in all groups.

TABLE 1

| | | Mineral content | | | Chemical equivalent | | |
|---|---|---|---|---|---|---|---|
| Immersion time | | K | Mg | Na | K | Mg | Mg/K |
| (hour) | | (mg/100 g) | | | (mEq/100 g) | | (mEq ratio) |
| (Control) | 0 | 1900 | 220 | 0.0 | 48.59 | 18.09 | 0.37 |
| | 1 | 1890 | 218 | 0.0 | 48.34 | 17.93 | 0.37 |
| | 2 | 1890 | 218 | 0.0 | 48.34 | 17.93 | 0.37 |
| | 3 | 1872 | 216 | 0.0 | 47.88 | 17.76 | 0.37 |
| | 5 | 1807 | 216 | 0.0 | 46.21 | 17.76 | 0.38 |
| | 8 | 1761 | 214 | 0.0 | 45.04 | 17.60 | 0.39 |
| | 16 | 1697 | 212 | 0.0 | 43.40 | 17.43 | 0.40 |
| | 24 | 1623 | 208 | 0.0 | 41.51 | 17.11 | 0.41 |

### Comparative Example 2

Soybeans classified into 7 groups were subjected to the same processing and chemical analysis as in Comparative Example 1 except that they were immersed in aqueous solution in which sodium chloride of 40 g was dissolved in deionized water of 1 letter. The results are shown in Table 2.

As dearly shown in Table 2, the K content and Mg content of the beans were dearly decreased by being immersed in water, and further decreased as compared with Comparative Example 1. Furthermore, as the immersion time became longer, the reduction degree thereof decreased. Especially, the reduction of K content was remarkable.

Although the Mg/K chemical equivalent ratio was 0.39 to 0.43 and some of them exceeded 0.4, the Mg content decreased in this Comparative Example.

TABLE 2

| | | Mineral content | | | Chemical equivalent | | |
|---|---|---|---|---|---|---|---|
| Immersion time | | K | Mg | Na | K | Mg | Mg/K |
| (hour) | | (mg/100 g) | | | (mEq/100 g) | | (mEq ratio) |
| (Control) | 0 | 1900 | 220 | 0.0 | 48.59 | 18.09 | 0.37 |
| | 1 | 1761 | 216 | 235 | 45.04 | 17.76 | 0.39 |
| | 2 | 1697 | 198 | 265 | 43.40 | 16.28 | 0.38 |
| | 3 | 1678 | 198 | 294 | 42.92 | 16.28 | 0.38 |
| | 5 | 1614 | 197 | 294 | 41.28 | 16.20 | 0.39 |
| | 8 | 1558 | 195 | 353 | 39.85 | 16.04 | 0.40 |
| | 16 | 1448 | 191 | 367 | 37.03 | 15.71 | 0.42 |
| | 24 | 1346 | 182 | 386 | 34.42 | 14.97 | 0.43 |

### Example 1

Soybeans classified into 7 groups were subjected to the same processing and chemical analysis as in Comparative Example 1 except that they were immersed in aqueous solution in which magnesium chloride of 3.0 g was dissolved in deionized water of 1 letter. The results are shown in Table 3.

As will be apparent from Table 3, in the soybeans immersed in the aqueous solution, the K content dearly decreased as compared with the control soybeans. As the immersion time became longer, the reduction degree thereof further decreased. To the contrary, the Mg content increased by about 18 to 22 mg regardless of the immersion time.

That is, the immersion of the soybeans into the magnesium chloride aqueous liquid caused the K content in the soybeans to decrease, but causes the Mg content to increase when the immersion time exceeded one hour. The Mg/K chemical equivalent ratio increased from 0.37 of the original beans to 0.41 to 0.50.

TABLE 3

| | | Mineral content | | | Chemical equivalent | | |
|---|---|---|---|---|---|---|---|
| Immersion time | | K | Mg | Na | K | Mg | Mg/K |
| (hour) | | (mg/100 g) | | | (mEq/100 g) | | (mEq ratio) |
| (Control) | 0 | 1900 | 220 | 0.0 | 48.59 | 18.09 | 0.37 |
| | 1 | 1863 | 238 | 2.0 | 47.65 | 19.57 | 0.41 |
| | 2 | 1807 | 238 | 6.5 | 46.21 | 19.57 | 0.42 |
| | 3 | 1789 | 240 | 10.1 | 45.75 | 19.74 | 0.43 |
| | 5 | 1752 | 242 | 10.5 | 44.81 | 19.90 | 0.44 |
| | 8 | 1687 | 240 | 10.4 | 43.15 | 19.74 | 0.46 |
| | 16 | 1641 | 238 | 6.0 | 41.97 | 19.57 | 0.47 |
| | 24 | 1540 | 238 | 1.5 | 39.39 | 19.57 | 0.50 |

### Example 2

Soybeans classified into 7 groups were subjected to the same processing and chemical analysis as in Comparative Example 1 except that they were immersed in aqueous solution in which sodium chloride of 40 g and magnesium chloride of 3.0 g were dissolved in deionized water of 1 letter. The results are shown in Table 4.

As will be apparent from Table 4, the K content in the soybeans clearly decreased by the immersion into the mixed aqueous solution including sodium chloride and magnesium chloride. As the immersion time became longer, the reduction degree thereof further decreased, and the reduction rate was larger than that in Comparative Example 1.

That is, in this example, the immersion of the soybeans for one hour or more caused the K content in the soybeans to decrease, but caused the Mg content to increase when the immersion time was 1 to 24 hours, preferably 3 to 8 hours. The Mg/K chemical equivalent ratio increased from 0.37 of the original beans to 0.45 to 0.52.

TABLE 4

| | | Mineral content | | | Chemical equivalent | | |
|---|---|---|---|---|---|---|---|
| Immersion time | | K | Mg | Na | K | Mg | Mg/K |
| (hour) | | (mg/100 g) | | | (mEq/100 g) | | (mEq ratio) |
| (Control) | 0 | 1900 | 220 | 0.0 | 48.59 | 18.09 | 0.37 |
| | 1 | 1632 | 229 | 235 | 41.74 | 18.83 | 0.45 |
| | 2 | 1614 | 233 | 265 | 41.28 | 19.16 | 0.46 |
| | 3 | 1614 | 237 | 294 | 41.28 | 19.49 | 0.47 |
| | 5 | 1577 | 238 | 321 | 40.33 | 19.57 | 0.49 |
| | 8 | 1484 | 237 | 366 | 37.95 | 19.49 | 0.51 |
| | 16 | 1457 | 225 | 371 | 37.26 | 18.50 | 0.50 |
| | 24 | 1374 | 221 | 390 | 35.14 | 18.17 | 0.52 |

### Comparative Example 3

The same processing as in Comparative Example 2 was performed except that original soybeans were immersed for 5 hours in aqueous solutions classified into seven levels of sodium chloride from 0.1% to 20.0%.

K, Mg and Na contents are shown in Table 5. Contrast in Table 5 denotes soybeans not immersed in the aqueous solution.

On the other hand, the immersion processed soybeans were subjected to drying processing and then grinding processing to thereby be grinded into 250 μm to 450 μm. Then, the taste was evaluated by 7 panelists. The results are shown in Table 6.

The results of sampling examination regarding Smell, Sweet taste, Salty taste of the food material after cooking were evaluated by six-level evaluations, i.e., “None, Slight, Weak, Medium, Medium high, Strong” and shown by the mean value of the seven panelists.

TABLE 5

| | Mineral content | | | Chemical equivalent | | |
|---|---|---|---|---|---|---|
| NaCl concentration | K | Mg | Na | K | Mg | Mg/K |
| (%) | (mg/100 g) | | | (mEq/100 g) | | (mEq ratio) |
| Control | 1900 | 220 | 0.0 | 48.59 | 18.09 | 0.37 |
| 0.1 | 1752 | 212 | 20 | 44.81 | 17.43 | 0.39 |
| 0.4 | 1697 | 210 | 40 | 43.40 | 17.27 | 0.40 |
| 1.0 | 1669 | 210 | 54 | 42.69 | 17.27 | 0.40 |
| 4.0 | 1632 | 210 | 160 | 41.74 | 17.27 | 0.41 |
| 6.0 | 1632 | 212 | 285 | 41.74 | 17.43 | 0.42 |
| 10.0 | 1604 | 210 | 525 | 41.02 | 17.27 | 0.42 |
| 20.0 | 1586 | 209 | 623 | 40.56 | 17.19 | 0.42 |

TABLE 6

| NaCl | Evaluation Items | | |
|---|---|---|---|
| concentration (%) | Smell | Sweet taste | Salty taste |
| Control | Medium high | Slight | None |
| 0.1 | None | Slight | None |
| 0.4 | None | Sight | None |
| 1.0 | None | Weak | None |
| 4.0 | None | Medium | None |
| 6.0 | None | Medium high | Weak |
| 10.0 | None | Medium high | Medium high |
| 20.0 | None | Medium high | Strong |

As will be apparent from Table 5, as a result of 5 hours immersion in the sodium chloride aqueous solution, the K content in soybeans decreased by about 150 mg to about 300 mg, which is contrary to the sodium chloride concentration of the solution. Furthermore, the Mg content decreased by about 10 mg in each concentration. As also shown in Comparative Example 2, the immersion in sodium chloride aqueous solution is not preferable from the view point of Mg-enriching. The Mg/K chemical equivalent ratio was merely 0.39 to 0.42 as opposed to 0.37 of original beans.

Furthermore, as will be apparent from the sampling result, in the case of control soybeans, smell peculiar to the food material was observed clearly. To the contrary, in the case of the immersed soybeans, five (5) panelists among seven (7) panelists could not detect smell, and therefore this immersion conditions brought preferable effects for the purpose of removing odors.

Next, in the sweet taste evaluation, in the case of the control soybeans, the evaluation was “Slight.” The same evaluation was obtained in the case of the soybeans of the sodium chloride concentration of 0.1% and 0.4%. However, it was judged as “Weak” at 1.0%, “Medium” at 4.0%, and dearly “Medium high” at 6.0% to 20.0%.

Furthermore, regarding the salty taste, in the same manner as in the control soybeans which was evaluated as “None,” in the samples too, the evaluation was “None” at the sodium chloride concentrabon of 0.1% to 4.0% irrespecive of the immersion in sodium chloride aqueous solution. However, it was evaluated as “Weak” at 6.0%, “Medium high” at 10.0%, clearly “Strong” at 20.0%.

That is, regarding the sodium chloride, there is a characteristic tendency that the salty taste is seldom detected below the concentration of 5.0% as a boundary but clearly detected above the concentration. This means, from the view point of the Na content in a food material, that almost no sweet taste could not be recognized when the Na content is about 50 mg or less, a sweet taste could be recognized when the Na content is about 50 mg to about 285 mg, and a sweet taste and a salty taste could be dearly recognized when the Na content is about 285 mg or above. By utilizing these effects, a food material given to “sweet taste only” or “sweet taste and salty taste” can be obtained.

### Example 3

The same processing as in Example 1 was performed except that original soybeans were immersed for 5 hours in aqueous solutions classified into seven levels of sodium chloride from 0.15% to 1.2%. The K, Mg and Na contents are shown in Table 7. In the same manner as in Comparative Example 3, sample test results made by seven (7) panelists are shown in Table 8.

TABLE 7

| | Mineral content | | | Chemical eqivalent | | |
|---|---|---|---|---|---|---|
| MgCl₂ concentration | K | Mg | Na | K | Mg | Mg/K |
| (%) | (mg/100 g) | | | (mEq/100 g) | | (mEq ratio) |
| Control | 1900 | 220 | 0.0 | 48.59 | 18.09 | 0.37 |
| 0.15 | 1743 | 214 | 0.0 | 44.58 | 17.60 | 0.39 |
| 0.30 | 1724 | 202 | 0.0 | 44.09 | 16.61 | 0.38 |
| 0.45 | 1687 | 244 | 0.0 | 43.15 | 20.07 | 0.47 |
| 0.60 | 1724 | 250 | 1.0 | 44.09 | 20.56 | 0.47 |
| 0.75 | 1733 | 259 | 2.0 | 44.32 | 21.30 | 0.48 |
| 0.90 | 1715 | 261 | 5.5 | 43.86 | 21.46 | 0.49 |
| 1.20 | 1697 | 271 | 12.1 | 43.40 | 22.29 | 0.51 |

TABLE 8

| MgCl₂ | Evaluation Items | | |
|---|---|---|---|
| concentration (%) | Smell | Sweet taste | Salty taste |
| Control | Medium high | Slight | None |
| 0.15 | None | Slight | None |
| 0.30 | None | Weak | None |
| 0.45 | None | Medium high | None |
| 0.60 | None | Medium high | None |
| 0.75 | None | Medium high | None |
| 0.90 | None | Medium high | None |
| 1.20 | None | Medium high | Medium high |

As will be apparent from Table 7, the K content decreased by about 180 mg on the average due to the immersion into the magnesium chloride aqueous solution with no influence of the magnesium chloride concentration. On the other hand, the Mg content increased in proportion to the magnesium chloride concentration of the aqueous solution. From the view point of Mg-enriching, higher magnesium chloride concentration is preferable In the case of 5 hours immersion in the aqueous solution of concentration of 0.45% to 1.2%, the Mg/K chemical equivalent ratio increased from 0.37 of the original beans and enhanced to 0.47 to 0.51.

Furthermore, as will be apparent from Table 8, in the control soybeans, odor specific to the food material which will generally generate when the food material is cooked, i.e., weak “heartburn” which is felt immediately after swallowing and “return smell” which goes through nasal passages was clearly felt. To the contrary, in this Example, six (6) panelists among seven (7) panelists could recognize no odor. Accordingly, the immersed soybeans of this Example could have brought dear preferable unconventional effects to taste.

Next, in the sweet taste evaluation, in the case of the control soybeans, the evaluation was “Slight.” The same evaluation was obtained in the case of the soybeans of the sodium chloride of 0.15%. However, it was judged as “Weak” at 0.30% to 0.45%, and clearly “Medium high” at 0.45% to 1.20%. Although magnesium chloride usually gives bitter taste, it is recognized that it gives sweet taste when soybeans are immersed in diluted aqueous solution of an appropriate concentration. However, at 1.20%, the evaluation was “Medium high” because of coexistence of bitter taste specific to magnesium chloride. Accordingly, the amount to be added had the upper limit in terms of taste, and a food material manufactured in the range of 0.30 to 0.90% was preferable.

### Comparative Example 4

With respect to kidney beans, broad beans, cow peas, lima beans, chick peas, lentils and black lentils (Gankui-mame), in the same manner as in Comparative Example 1, the content of K, Mg and Na and the chemical equivalent were measured by atomic absorption method. The results are shown in Table 9.

As apparent from Table 9, the lowest Mg/K chemical equivalent ratio was 0.29 of lima beans, and the highest ratio was 0.40 of black lentils (Gankui-mame) among the third group of comparative beans. Except for black lentis (Gankui-mame), none of them could have solved the problems to be solved by the present invention.

TABLE 9

| | Mineral content | | | Chemical equivalent | | |
|---|---|---|---|---|---|---|
| | K | Mg | Na | K | Mg | Mg/K |
| Material beans | (mg/100 g) | | | (mEq/100 g) | | (mEq ratio) |
| Kidney beans | 1500 | 150 | 0.0 | 38.36 | 12.34 | 0.32 |
| Broad beans | 1100 | 120 | 0.0 | 28.13 | 9.87 | 0.35 |
| Cow beans | 1400 | 170 | 0.0 | 35.81 | 13.98 | 0.39 |
| Lima beans | 1900 | 170 | 0.0 | 48.59 | 13.98 | 0.29 |
| Chick peas | 1200 | 140 | 0.0 | 30.69 | 11.51 | 0.38 |
| Lentils | 1000 | 100 | 0.0 | 25.58 | 8.22 | 0.32 |
| Black lentils | 2000 | 250 | 0.0 | 51.15 | 20.56 | 0.40 |
| (Gankui-mame) | | | | | | |

### Example 5

A method of manufacturing a food material in which kidney beans, broad beans, cow peas, lima beans, chick peas, lentils and black lentils (Gankui-mame) as material beans are immersed respectively in aqueous solution in which magnesium chloride and sodium chloride were dissolved to thereby enrich Mg and Na, reform the mineral composition and improve the taste will be explained.

Immersing aqueous solution of magnesium chloride concentration of 0.375% and sodium chloride of 2.0% was prepared by dissomng a certain amount of purified bittern obtained by salt farm method (containing bittern for “tofu” made by Kabushiki Kaisha Tenshio: magnesium chloride content of 51%, magnesium sulfate content of 3.40/%, sodium chloride content of 2.6%, potassium chloride content of 0.5%, crystal water of about 42.5%) and sodium chloride as food additive in water.

Then, kidney beans, broad beans, cow peas, lima beans, chick peas, lentils and black lentils (Gankui-mame) of 500 g were immersed respectively in the aforementioned aqueous solution of 1 letter and kept for five (5) hours. The temperature of the aqueous solution during the immersion was kept to 17° C. or below for the purpose of preventing the increase of general viable cell count causing odor and bacillus family bacteria, etc., which is thermostable spore bacteria causing food poisoning. By this operation, elution of potassium contained in material beans into water phase and enriching of water phase magnesium into the material beans were performed.

After the completion of the immersing, the material beans were put in a stainless steel colander to drop the water and adjusted the water content into about 12.5% by forced-air drying in a low temperature chamber of 8° C.

The K, Mg and Na content of the obtained food material was measured in the same method as in the aforementioned Example 1. The results are shown in Table 10.

As apparent from Table 10, in kidney beans, broad beans, cow peas, lima beans, chick peas, lentis and black lentils (Gankui-mame), the K content after the immersion decreased as compared with that before the immersion, and Mg content and Na content increased. Furthermore, in Comparative Example 4, the lowest Mg/K chemical equivalent ratio was 0.29 of lima beans, and the highest ratio was 0.40 of black lentils (Gankui-mame). To the contrary, in this Example, the lowest ratio was 0.40 of lima beans, and the highest ratio was 0.60 of black lentils (Gankui-mame), and it was confirmed that the mineral composition was reformed to the Mg/K chemical equivalent ratio capable of solving the problems to be solved by the present invention.

Furthermore, as shown in Table 10, the Mg content of black lentils (Gankui-mame) was larger than that of the other beans and the Mg/K chemical equivalent ratio was also larger than that of the other beans. Therefore, it is understood that black lentils (Gankui-mame) can be used most appropriately as a food material reformed in mineral composition.

As mentioned above, in this example, a food material reformed in mineral component of beans increased in Mg content, enhanced in Mg/K chemical equivalent ratio, improved in handling because of the drying treatment, improved in safeness due to the suppressed increase of general viable cell count and thermostable spore bacteria, and also improved in taste was manufactured.

TABLE 10

| | Mineral content | | | Chemical equivalent | | |
|---|---|---|---|---|---|---|
| | K | Mg | Na | K | Mg | Mg/K |
| Material beans | (mg/100 g) | | | (mEq/100 g) | | (mEq ratio) |
| Kidney beans | 1200 | 168 | 0.0 | 30.69 | 13.82 | 0.45 |
| Broad beans | 880 | 134 | 0.0 | 22.51 | 11.05 | 0.49 |
| Cow beans | 1120 | 190 | 0.0 | 28.64 | 15.66 | 0.55 |
| Lima beans | 1520 | 190 | 0.0 | 38.87 | 15.66 | 0.40 |
| Chick peas | 960 | 157 | 0.0 | 24.55 | 12.89 | 0.53 |
| Lentils | 800 | 112 | 0.0 | 20.46 | 9.21 | 0.45 |
| Black lentils | 1550 | 290 | 1.0 | 39.64 | 23.85 | 0.60 |
| (Gankui-mame) | | | | | | |

### Comparative Example 5

With respect to barley, wheat, rye, in the same manner as in Comparative Example 1, the content of K, Mg and Na and the chemical equivalent were measured by atomic absorption method. The results are shown in Table 11.

As apparent from Table 11, the lowest Mg/K chemical equivalent ratio was 0.55 of wheat, and the highest ratio was 0.72 of rye among the first group of comparative beans.

TABLE 11

| | Mineral content | | | Chemical equivalent | | |
|---|---|---|---|---|---|---|
| | K | Mg | Na | K | Mg | Mg/K |
| Material Mugi | (mg/100 g) | | | (mEq/100 g) | | (mEq ratio) |
| Barley | 230 | 50 | 0.0 | 5.88 | 4.11 | 0.70 |
| Wheat | 470 | 80 | 0.0 | 12.02 | 6.58 | 0.55 |
| Rye | 400 | 90 | 0.0 | 10.23 | 7.40 | 0.72 |

### Comparative Example 6

A food material in which barley, wheat, rye as material beans were immersed respectively in aqueous solution in which magnesium chloride and sodium chloride were dissolved to thereby enrich Mg and Na, reform the mineral composition and improve the taste was obtained. Mugi-rui in which shell or skin was removed from the kernel were used.

That is, the same processing as in Example 5 was performed and the K, Mg and Na content of the obtained food material was measured in the same method as in the aforementioned Example 5 except that materials are barley, wheat or rye. The results are shown in Table 12.

As apparent from Table 12, in barley, wheat or rye, the K content after the immersion decreased as compared with that before the immersion, and the Mg content and the Na content increased. Furthermore, in Comparative Example 5, the lowest Mg/K chemical equivalent ratio was 0.55 of wheat, and the highest ratio was 0.72 of rye. To the contrary, in this group, the lowest ratio was 0.81 of wheat, and the highest ratio was 1.01 of rye, and it was confirmed that the mineral composition was refined up to the Mg/K chemical equivalent ratio capable of solving the problems to be solved by the present invention.

As mentioned above, in this example, a food material reformed in mineral component of Muri-rui increased in Mg content, enhanced in Mg/K chemical equivalent ratio, improved in handling because of the drying treatment, improved in safeness due to the suppressed increase of general viable cell count and thermostable spore bacteria, and also improved in taste was manufactured.

TABLE 12

| | Mineral content | | | Chemical equivalent | | |
|---|---|---|---|---|---|---|
| | K | Mg | Na | K | Mg | Mg/K |
| Material Mugi | (mg/100 g) | | | (mEq ratio) | | (mEq ratio) |
| Barley | 184 | 56 | 0.0 | 4.71 | 4.61 | 0.98 |
| Wheat | 376 | 95 | 0.0 | 9.62 | 7.81 | 0.81 |
| Rye | 320 | 101 | 0.0 | 8.18 | 8.29 | 1.01 |

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.”In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

1. A food material reformed in mineral composition, comprising:
beans enriched in magnesium content,
wherein chemical equivalent ratio of magnesium of the beans with respect to a chemical equivalent of potassium thereof falls within the range of 0.4 to 2.0.

2. The food material reformed in mineral composition as recited in claim 1, wherein the beans are enriched in magnesium content by immersing the beans into aqueous solution containing magnesium chloride to decrease the potassium content.

3. The food material reformed in mineral composition as recited in claim 1, wherein the beans are further enriched in sodium.

4. The food material reformed in mineral composition as recited in claim 3, wherein the beans are enriched in magnesium content and sodium content by immersing the beans into aqueous solution containing magnesium chloride and sodium chloride to decrease the potassium content.

5. The food material reformed in mineral composition as recited in claim 1, wherein the beans are soybeans, kidney beans, broad beans, cow peas, lima beans, chick peas, or lentils.

6. The food material reformed in mineral composition as recited in claim 5, wherein the soybeans are black lentils (Gankui-mame).

7. A food material reformed in mineral composition, comprising:
Mugi-rui enriched in magnesium content,
wherein chemical equivalent ratio of the Mugi-rui with respect to chemical equivalent of potassium thereof falls within the range of 0.8 to 3.0.

8. The food material reformed in mineral composition as recited in claim 7, wherein the Mugi-rui is enriched in magnesium content by immersing the Mugi-rui into aqueous solution containing magnesium chloride to decrease the potassium content.

9. The food material reformed in mineral composition as recited in claim 7, wherein the Mugi-rui is further enriched in sodium.

10. The food material reformed in mineral composition as recited in claim 9, wherein the Mugi-rui is enriched in magnesium content and sodium content by immersing the Mugi-rui into aqueous solution containing magnesium chloride and sodium chloride to decrease the potassium content.

11. The food material reformed in mineral composition as recited in claim 7, wherein the Mugi-rui is barleys, wheat, rye, or oats.

12. A method of manufacturing a food material, comprising:
immersing beans or Mugi-rui in aqueous solution containing magnesium chloride for more than one hour,
wherein magnesium chloride concentration of the aqueous solution falls within the range of 0.01 to 10.0% (weight/capacity).

13. The method of manufacturing a food material as recited in claim 11, wherein the aqueous solution including magnesium chloride further contains sodium chloride, the sodium chloride concentration of the aqueous solution falling within the rang of 0.1 to 20.0% (wegith/capacity), and wherein the beans or Mugi-rui are immersed in the aqueous solution containing the magnesium chloride and the sodium chloride for more than one hour.

14. A method of reforming mineral composition of beans, comprising:
immersing beans in aqueous solution containing magnesium chloride for more than one hour to decrease potassium content of the beans and enrich magnesium content so that chemical equivalent ratio of magnesium with respect to chemical equivalent of potassium falls within the range of 0.4 to 2.0.

15. The method of reforming mineral composition as recited in claim 14, wherein magnesium chloride concentration in the aqueous solution falls within the range of 0.01 to 10.0% (weight/capacity).

16. The method of reforming mineral composition as recited in claim 14, wherein the aqueous solution containing the magnesium chloride further contains sodium chloride.

17. The method of reforming mineral composition as recited in claim 16, wherein magnesium chloride concentration of the aqueous solution falls within the range of 0.01 to 10.0% (weight/capacity), and wherein sodium chloride concentration of the aqueous solution falls within the range of 0.1 to 20.0% (weight/capacity).

18. A method of reforming mineral composition of Mugi-rui, comprising:
immersing Mugi-rui in aqueous solution containing magnesium chloride for more than one hour to decrease potassium content of the Mugi-rui and enrich magnesium content so that a chemical equivalent ratio of magnesium with respect to a chemical equivalent of potassium falls within the range of 0.8 to 3.0.

19. The method of reforming mineral composition as recited in claim 18, wherein magnesium chloride concentration of the aqueous solution falls within the range of 0.01 to 10.0% (weight/capacity).

20. The method of reforming mineral composition as recited in claim 18, wherein the aqueous solution of the magnesium chloride further contains sodium chloride.
